(19) United States
(12) Patent Application Publication
(10) Pub. No.: US 2002/0078036 A1
(43) Pub. Date: Jun. 20, 2002

(54) Exploiting familiar media attributes and vocabulary to access network resources

(76) Inventors: Marc D. Miller, Corte Madera, CA (US); Peter W.G. Harmon, Portland, OR (US)

Correspondence Address: DIGIMARC CORPORATION, 19801 SW 72ND AVENUE, SUITE 100, TUALATIN, OR, 97062, US

(21) Appl. No.: 09/942,026

(22) Filed: Aug. 28, 2001

Related U.S. Application Data
(60) Provisional application No. 60/229,835, filed on Aug. 30, 2000.

(51) Int. Cl. G06F 7/00

(52) U.S. Cl. 707/3

(57) ABSTRACT

The familiar vocabulary used to index content in print media, such as a publication's title, issue and page number, serves as a link to related information on the Internet. At a user's computer, the user uses this vocabulary to index a particular content item (such as an advertisement or article). A database system uses this information to look up a network address or addresses of related information or actions on a computer network, like the Internet. The system either automatically returns related information from that address to the user's computer, or returns the addresses themselves and allows the user or user's computer to control accessing information or actions at those addresses.

### RELATED APPLICATION DATA

This Application claims benefit of Provisional Application No. 60/229,835, filed Aug. 30, 2000.

### BACKGROUND AND SUMMARY

As the complexity and vastness of the Internet grows, seemingly without bound, there is an ever-increasing demand for new technologies to assist users to find information on the network. Popular search engine technology provides a way to index and search information stored on the Internet and other computer networks, but studies show that these search engines provide only a small fraction of the content stored in computer systems on the network.

Over time, new technologies have enhanced our ability to access and share information. Despite the evolution of new information technologies, many of the traditional mechanisms for conveying information such as print media (e.g., magazines, newspapers, books, mailings, etc.), radio, television and movies remain a central part of our every day life. As new information technologies are developed, they can leverage the familiarity of these traditional media types to simplify the way we use new technologies. One example of this approach is technology that employs embedded, machine readable codes in physical and electronic media objects (print media, documents, images, video, and audio) that link the objects to related information and actions on the Internet. See for example, assignee's work described in pending U.S. patent application Ser. No. 09/571,422 entitled Methods and Systems for Controlling Computers or Linking to Internet Resources From Physical and Electronic Objects; see also U.S. Pat. Nos. 5,862,260, 6,122,403 and 5,841,978 and co-pending application Ser. No. 09/503,881, filed Feb. 14, 2000; which are hereby incorporated by reference.

This disclosure describes systems and related methods for exploiting familiar media attributes and vocabulary to access network resources. The system is particularly suited for linking content in print media to related content or software programs on the Internet. However, it can be extended to link other types and forms of content to network resources as well.

In the system detailed below, the familiar vocabulary used to index content in print media, such as a publication's title, issue and page number, serves as a link to related information on the Internet. At a user's computer, the user uses this vocabulary to index a particular content item (such as an advertisement or article). A database system uses this information to look up a network address or addresses of related information or actions on a computer network, like the Internet. The system either automatically returns related information from that address to the user's computer, or returns the addresses themselves and allows the user or user's computer to control accessing information or actions at those addresses.

Further features will become apparent with reference to the following detailed description and accompanying drawings.

### BRIEF DESCRIPTION OF THE DRAWINGS

FIG. 1 is a diagram illustrating an example of a system for linking content in print publications to network resources on the Internet based on a familiar publication coding vocabulary.

FIG. 2 is a diagram of an alternative user interface for the user application shown in FIG. 1.

FIG. 3 illustrates an example of a computer system that serves as an operating environment for the system shown in FIG. 1.

### DETAILED DESCRIPTION

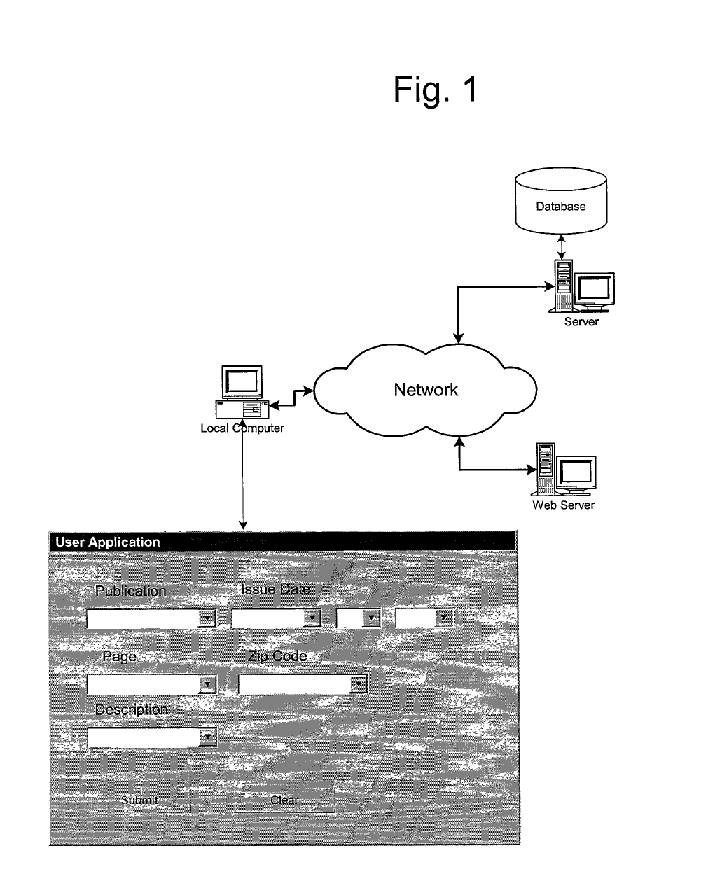

FIG. 1 is a diagram illustrating an example of a system for linking content in print publications to network resources on the Internet based on a familiar publication coding vocabulary. The system has three principle components: a local computer, which may be a variety of computing devices such as Personal Computer, Personal Digital Assistant, Smart Phone, Wireless Phone, Set Top Box with Television, audio or video player, etc.; a database management system, and a web server. Each of these components is interconnected on a computer network, namely the Internet. The term “local” in “local computer” means that this device provides the interface between the linking system and the user.

The system shown in FIG. 1 enables a user to access information about content in a publication from the Internet by using the coding vocabulary of the publication. In particular, the coding vocabulary of a publication includes the name of the publication, the issue, and the page number. Additional coding may include descriptors of the content found in the publication, such as names of popular figures, news topics, etc. Often, a user wants to find out more information about the content in a publication or purchase a product or service advertised in the publication over the Internet. This system provides a convenient mechanism to link content in the publication to related information or actions (e.g., electronic transactions or streaming content delivery) on the Internet. The related information is typically stored and presented in the form of HTML documents transmitted by web servers, but it need not be provided in this form. The related actions are typically stored in the form of program code (HTML, scripts, applets, etc.), which is either executed remotely, delivered to and executed on the local computer, or executed in a distributed fashion, partly on the local computer and partly on one or more other computers.

The system shown in FIG. 1 may be incorporated into or used in conjunction with a system that links print media to related information and actions on the Internet via machine readable codes steganographically embedded in the print media. Systems and applications for linking objects to network resources are described in the patents and patent applications incorporated by reference above.

The linking system described in this document can enhance systems that automatically link content to a network via machine readable codes because they provide additional ways to link the content to network resources. In addition, the linking system includes a searchable database that enables users to find information of interest in print media. In summary, the linking system facilitates accessing information and actions related to content on the Internet, and improves the value of the content by providing a system for user's to locate pertinent content in publications via the searchable database.

A user application executing on the local computer presents a user interface, such as the one shown in FIG. 1, to solicit user input of content attributes of an item of interest in a publication. The attributes represent content indexing that is already present in the publication, such as magazine name, issue, and page number. In the example shown in FIG. 1, the user interface includes a graphical display that enables the user to select or enter a magazine name, issue date, page number, zip code, and content description. After the user enters the publication code information in the respective fields, the user selects the submit button in the user interface.

In response, the application sends this information (or a parsed version of it), to a server via the network using conventional data transfer protocols and formats such as TCP/IP, HTTP, and XML. This server communicates with a database management system that converts the content index information submitted by the user into related information or actions.

The database management system uses the content index information to query a database for one or more corresponding entries. The entries in the database are indexed by publication name, issue date, page, and potentially other descriptors that represent the subject matter of content such as articles or advertisements. These entries indicate information or actions, or more specifically, network addresses of information or actions on the network, such as URLs or IP addresses of pertinent web pages, or other devices or programs that perform actions linked to the publication content, such as downloading or streaming media content, searching for related information on the Internet, a web page that manages electronic commercial transactions for products or services, etc.

The database management system returns the results of the database query to the server. The server then either returns the query results to the local computer, acts upon them itself, or forwards them to another device or computer, such as a web server, that acts upon the results. In cases where more than one entry satisfy the result of a query, the server either internally decides whether to select one or more of the entries based on predetermined rules, or returns the query results to the local computer or another computer for resolution.

In one implementation, the entries are returned to the user application on the local computer. The user application then determines which entry to act upon, or gives the user the opportunity to select one. In particular, the user application displays a user interface indicating the types of information or actions that are linked to the article or advertisement of interest. The user can then select the information or item of interest. In response to a user's selection, the user application fetches the information or initiates the action(s) associated with the selected entry. This may entail launching an Internet browser and passing the network address (URL or IP address) associated with the selected entry to the browser, which in turn, fetches a web page or other information or programs from a web server at the network address. The browser then renders the information or program returned by the web server. Alternatively, the user application will establish a connection with the network resource specified by the network address, fetch the information or programs at the network address, and render them on the local computer.

The entries in the database may include a variety of information or instructions. The server may either act on the information or instructions itself, or pass it to another computer, such as the local computer or another server for processing. One type of information is a network address of a network resource, such as a web page or program, that is related to an item of content in the publication. Another type of information is data, such as data in HTML or XML content, that is returned to the user application for rendering or other processing in the local computer. Another type of information is a program or set of programs that are executed in the server, or forwarded to another computer, such as a web server or the local computer, for execution. These programs perform actions associated with the linked item of content in the publication. Examples of such actions include streaming related media (audio and video) to the local computer for play back on a media rendering device, searching for related HTML content on the Internet and returning it to the local computer for rendering on the display, adding an entry to a log that monitors interest in particular advertisements or articles, managing an electronic commerce transaction to buy products or services or to license rights to use content, etc.

There are a number of ways to implement the user interface of the user application. It may be implemented as part of an operating system or other application. In either case, it is active for receiving user input so long as the operating system or application is active. It may be graphical, such as the example shown in FIG. 1. It may execute solely on the local computer, may be distributed between the local computer and another server, or may execute remotely and use the local computer as a dumb terminal to solicit input and present output to the user.

The user interface shown in FIG. 1 interacts with the database management system to provide information about the types of publications, issues, and descriptors that are available. In particular, when the user queries the user interface for a list of publications and issues (e.g., via the list boxes in the interface of FIG. 1), the user application provides the list based on information obtained from the database. This enables the user application to provide a dynamically updated list of publications and issues from the database. Also, it obviates the need for the user application to maintain information from the database on the local computer, though it is useful to cache frequently used data from the database on the local computer.

It may also operate based on voice recognition. For instance, rather than requiring the user to enter the publication name, issue and page, the user can simply state this information. A voice recognition system interprets the digitized audio input from the microphone, identifies publication codes from this audio input, such as magazine names, issue dates, pages, and subject matter descriptors, and sends the identified codes to the database system for resolution. A voice recognition interface has been implemented using voice recognition capabilities built into the Macintosh Operating System from Apple Computer.

The user application may control access to the database based on attributes of the user. For example, the user may be authorized to obtain Internet content linked to certain magazines if the user has a subscription to those magazines. To manage this access, the user application sends information about the user, such as a logon and password, to the database, which in turn, returns information about publications for which that user has a subscription. The database maintains a table of users and their corresponding publication subscriptions to determine each user's level of access to the data and services provided by the system.

An enhancement to control access to content linked to a publication is to incorporate a watermark decoder in the user application. To verify that the user has a publication, the user scans a watermarked page of the publication to a digital camera or scanner. The watermark decoder in the application then forwards information about the publication extracted from the watermark to the database, which, in response, provides access to content and actions on the Internet that are related to the publication.

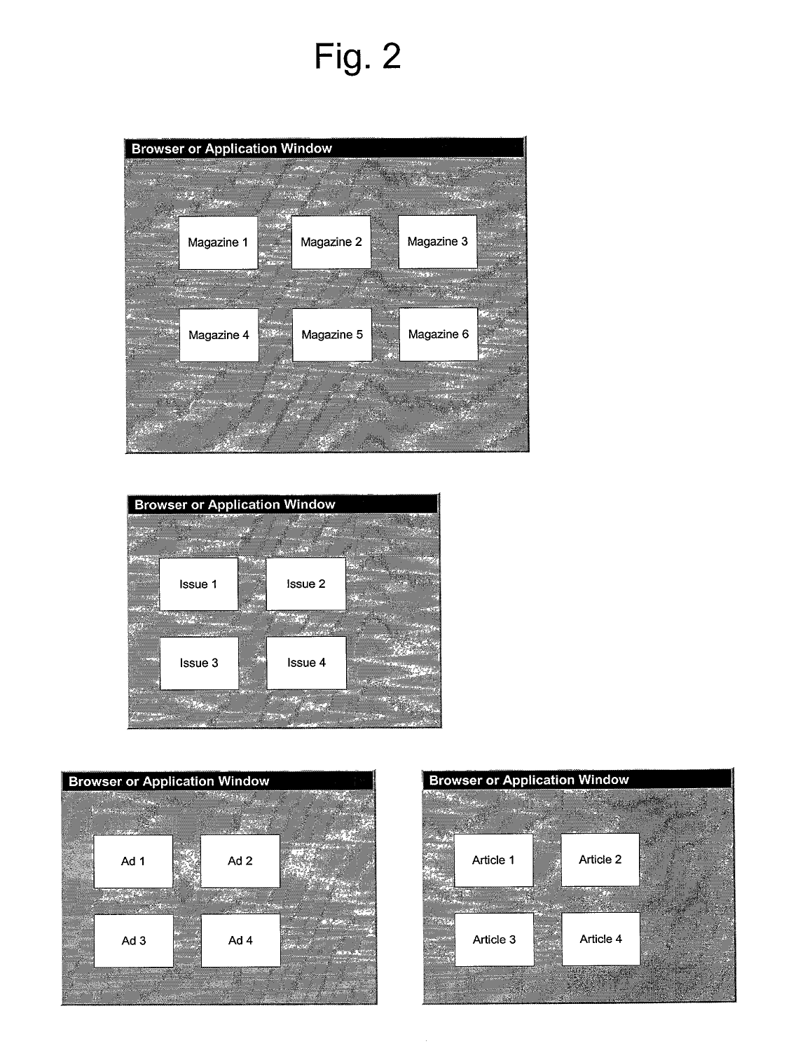

The user interface may be designed as part of a stand alone application that runs on the local computer, or in a web page that is accessible on Internet and that runs in an Internet browser. FIG. 2 illustrates an example of an HTML interface. The HTML interface comprises a collection of hyperlinked HTML pages that enable the user to select magazines, issues of magazines and content within those issues. The top or entry page of the HTML interface shows a graphical depiction of the publications linked to the Internet via the system. When the user selects a publication (e.g., clicks on a graphical icon representing the magazine), the interface links to a lower level HTML page showing the issues of that magazine in the system. When the user selects an issue, the interface links to additional lower level HTML pages showing a graphical or textual description of the advertisers (Ad1, Ad2, . . . ) or articles (Article 1, Article 2, . . . ) in the system. Finally, by selecting an article or advertiser, the browser fetches related information or actions linked to that article or advertiser in the database.

To accomplish this, the browser sends the user's selection of an article or advertisement to the database, which in turn, maps it to information or actions, such as a web site. The database may either return the URL or IP address to the browser, which then fetches the resource at that address, or may automatically route an HTTP request to the address, instructing the web server at that address to return the linked information or actions (e.g., a web page) back to the IP address of the requesting browser.

Alternatively, the URL or IP address may be coded into the lower level HTML page of the advertisements or articles in a selected publication issue. In this case, the browser fetches and renders the information or action (e.g., HTML page) at the URL or IP address coded into the lower level HTML page of the HTML interface.

The database of publication indexes (publication names, issues and pages) and linked information and actions can be further augmented with searchable descriptor fields using SQL or other relational database technology. In addition, the database management system can be extended to include a search interface, such an HTML based interface accessible using a browser on the Internet, or using a custom interface built into the user application. This type of search interface enables users with browsers or the user application to formulate database queries (e.g., SQL queries) based on key word search terms, like names of advertisers, news items, etc. to fetch information from the database that match the query. In response, the database management system searches the database for descriptors in the database entries that match the key word search terms or their variants in the query, and displays a list of matching entries to the user, either in an HTML page rendered by a browser, or in the user interface of the user application.

Each of the items in the search results is linked to information or actions stored in the corresponding database entry or entries. For example, the entries include one or more network addresses that either the local computer, or the server use to fetch linked information or actions from the server at the specified network address and return them to the local computer. The user may select an item in the search results to view the related links, if there are two or more addresses for that item, or to fetch the information or action associated with that item, if there is only one address for that item.

Operating Environment for System Implementations

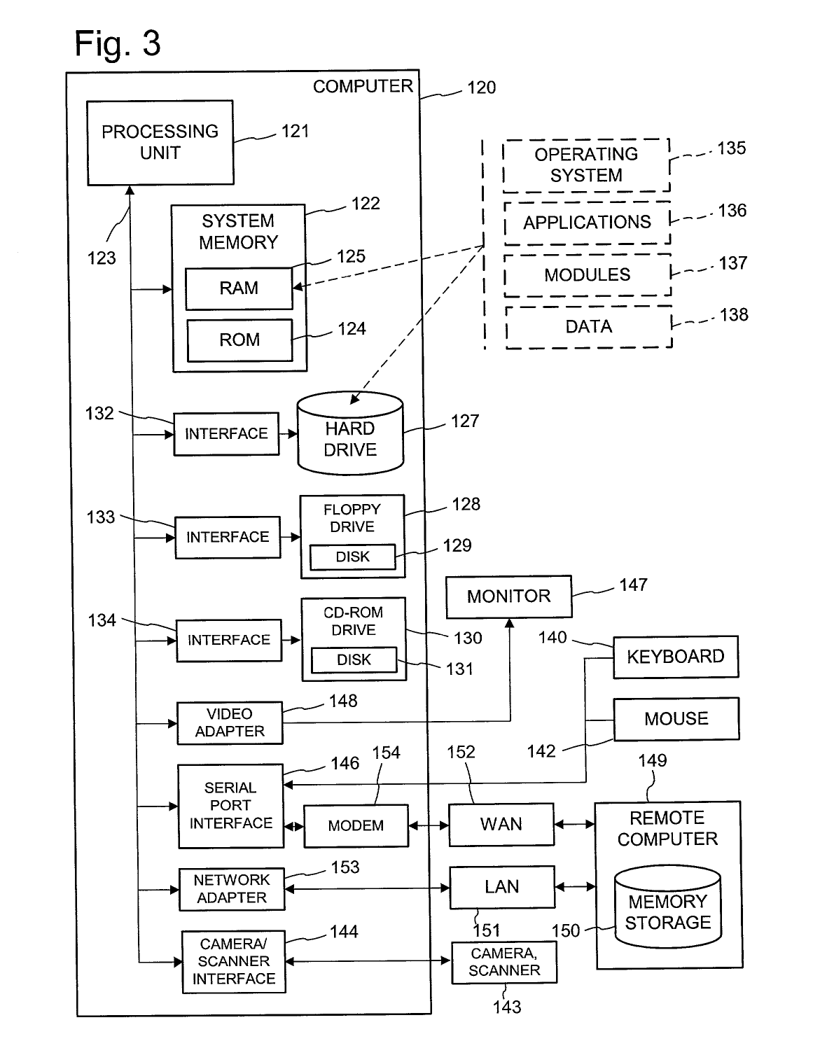

FIG. 3 illustrates an example of a computer system that serves as an operating environment for software implementations of the systems described above. The user and server applications are implemented in C/C++ and are portable to many different computer systems. FIG. 3 generally depicts one such system. The computer system shown in FIG. 3 includes a computer 120, including a processing unit 121, a system memory 122, and a system bus 123 that interconnects various system components including the system memory to the processing unit 121.

The system bus may comprise any of several types of bus structures including a memory bus or memory controller, a peripheral bus, and a local bus using a bus architecture such as PCI, VESA, Microchannel (MCA), ISA and EISA, to name a few.

The system memory includes read only memory (ROM) 124 and random access memory (RAM) 125. A basic input/output system 126 (BIOS), containing the basic routines that help to transfer information between elements within the computer 120, such as during start-up, is stored in ROM 124.

The computer 120 further includes a hard disk drive 127, a magnetic disk drive 128, e.g., to read from or write to a removable disk 129, and an optical disk drive 130, e.g., for reading a CD-ROM or DVD disk 131 or to read from or write to other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of data, data structures, computer-executable instructions (program code such as dynamic link libraries, and executable files), etc. for the computer 120.

Although the description of computer-readable media above refers to a hard disk, a removable magnetic disk and an optical disk, it can also include other types of media that are readable by a computer, such as magnetic cassettes, flash memory cards, digital video disks, and the like.

A number of program modules may be stored in the drives and RAM 125, including an operating system 135, one or more application programs 136, other program modules 137, and program data 138.

A user may enter commands and information into the computer 120 through a keyboard 140 and pointing device, such as a mouse 142. Other input devices may include a microphone, joystick, game pad, satellite dish, digital camera, scanner, or the like. A digital camera or scanner 43 may be used to capture a digital image of an object with a machine readable code (e.g., a digital watermark, bar code, etc.), which is used to index information, programs, or a network address of information or programs. The camera and scanner are each connected to the computer via a wire or wireless interface 44. Digital cameras are designed to interface with a Universal Serial Bus (USB), Peripheral Component Interconnect (PCI), and parallel port interface. Two emerging standard peripheral interfaces for cameras include USB2 and 1394 (also known as firewire and iLink).

Other input devices may be connected to the processing unit 121 through a serial port interface 146 or other port interfaces (e.g., a parallel port, game port or a universal serial bus (USB)) that are coupled to the system bus.

A monitor 147 or other type of display device is also connected to the system bus 123 via an interface, such as a video adapter 148. In addition to the monitor, computers typically include other peripheral output devices (not shown), such as speakers and printers.

The computer 120 operates in a networked environment using logical connections to one or more remote computers, such as a remote computer 149. The remote computer 149 may be a server, a router, a peer device or other common network node, and typically includes many or all of the elements described relative to the computer 120, although only a memory storage device 150 has been illustrated in FIG. 3. The logical connections depicted in FIG. 20 include a local area network (LAN) 151 and a wide area network (WAN) 152. Such networking environments are commonplace in offices, enterprise-wide computer networks, intranets and the Internet.

When used in a LAN networking environment, the computer 120 is connected to the local network 151 through a network interface or adapter 153. When used in a WAN networking environment, the computer 120 typically includes a modem 154 or other means for establishing communications over the wide area network 152, such as the Internet. The modem 154, which may be internal or external, is connected to the system bus 123 via the serial port interface 146.

In a networked environment, program modules depicted relative to the computer 120, or portions of them, may be stored in the remote memory storage device. The processes detailed above can be implemented in a distributed fashion, and as parallel processes. It will be appreciated that the network connections shown are exemplary and that other means of establishing a communications link between the computers may be used.

While the computer architecture depicted in FIG. 3 is similar to typical personal computer architectures, aspects of the invention may be implemented in other computer architectures, such as hand-held computing devices like Personal Digital Assistants, audio and/video players, network appliances, telephones, etc.

Concluding Remarks

Having described and illustrated the principles of the technology with reference to specific implementations, it will be recognized that the technology can be implemented in many other, different, forms. For example, the specific examples provided above relate to magazine publications, but the system may be adapted for many forms of print media, including product packaging, books, labels, product documentation, etc. To provide a comprehensive disclosure without unduly lengthening the specification, applicants incorporate by reference the patents and patent applications referenced above.

The methods, processes, and systems described above may be implemented in hardware, software or a combination of hardware and software. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

We claim:

1. A method for linking print media to a network resource comprising:
in a local computer, prompting a user for a publication content index selected from a familiar coding vocabulary of a publication;
from the local computer, sending the publication content index to a database management system;
in the database management system, searching for an entry corresponding to the publication content index; and
using an address in the entry to fetch information or a program from a device at the address.

2. The method of claim 1 further including:
sending the information or program to the local computer; and
rendering the information or program in the local computer.

3. The method of claim 1 wherein the publication content index includes a publication name and page number.

4. The method of claim 1 wherein the publication content index is entered by the user to the local computer via a voice recognition system.

5. The method of claim 1 wherein the database has a search interface that enables a user to search for print media content based on key words.

6. The method of claim 5 wherein the search results presented by the search interface are responsive to user input to provide a list of links to network resources or to link to a network resource based on one or more network addresses associated with the search results.
